(19) United States
(12) Patent Application Publication
(10) Pub. No.: US 2026/0091694 A1
(43) Pub. Date: Apr. 2, 2026

(54) METHOD AND SYSTEM FOR CHARGING AN ELECTRICALLY OPERATED VEHICLE ON A CHARGING DEVICE USING A CHARGING ADAPTER

(71) Applicant: MERCEDES-BENZ GROUP AG, Stuttgart (DE)

(72) Inventors: Rene MARQUARDT, Herrenberg (DE); Stefan WEIS, Tübingen (DE)

(21) Appl. No.: 19/341,262

(22) Filed: Sep. 26, 2025

(30) Foreign Application Priority Data
Sep. 27, 2024 (DE) 10 2024 003 149.9

(51) Int. Cl. B60L 53/16; B60L 53/62; B60L 53/65

(52) U.S. Cl. CPC B60L 53/16; B60L 53/62; B60L 53/65; B60L 2240/36

(57) ABSTRACT

After electrical connections are established between the charging plug of a charging cable of a charging device and plug-side connections of a charging adapter, it is checked whether the charging plug has a test resistor specific to the charging plug. A temporal charging profile is set for the charging process depending on presence of the test resistor. If the test resistor is absent when a NACS charging socket of the vehicle is present or the test resistor is present when a CCS1 charging socket of the vehicle is present, a charging current above a current limit value is maintained for at least a period of time. If the test resistor is present and when there a NACS charging socket of the vehicle or test resistor is absence and a CCS1 charging socket of the vehicle is present, a charging current is kept at a value below a current limit value.

### CROSS-REFERENCE TO RELATED APPLICATIONS

This application claims priority under 35 U.S.C. § 119 to German Patent Application No. 10 2024 003 149.9, filed on Sep. 27, 2024, the entire disclosure of which is expressly incorporated by reference herein.

### BACKGROUND AND SUMMARY OF THE INVENTION

Exemplary embodiments of the invention relate to a method for charging an electrically operated vehicle on a charging device using a charging adaptor between a charging socket on the side of the vehicle and an external charging plug of the charging device and a system comprising an electrically operated vehicle, a charging adaptor and a charging device for carrying out a method.

With the introduction of the North American Charging Standard (NACS) for charging an electrically operated vehicle on a charging device, a further specially developed charging plug has been established as the North American standard. Therefore, charging adapters have to be used to charge vehicles with other charging interfaces, such as those based on the Combined Charging System (CCS1) standard. Charging adapters are required in order to adapt charging cables from CCS1 to NACS interfaces and vice versa.

All adapter solutions disadvantageously introduce an additional plug connection into the system and thus additional contact resistance and heat emerge. Moreover, the charging adapters often use a reduced cable cross-section to be as compact and cost-effective as possible. Common charging adapters for charging vehicles with CCS1 interfaces on NACS charging devices or for charging vehicles with NACS interfaces on CCS1 charging devices have maximum possible current strengths of between 250 A and 500 A.

This means that these charging adapters are not sufficiently dimensioned and will be the limiting factor in almost every charging process. With increasingly larger batteries and increasing charging power, the problem will become even more severe. The transition to the NACS standard will mean that adapter charging will be used more frequently in the future.

Typically, the charging infrastructure transmits its maximum rating to the vehicle via a communication protocol (e.g., Smart Charge Communication SCC or CAN bus). However, since the charging adapter is unknown to the charging infrastructure, the potential overload protection is here bypassed.

Furthermore, the charging adapters do not have active cooling, as is the case with the so-called High Power Charger (HPC) infrastructure (water- or oil-cooled plugs and cables). This leads to extremely rapid heating and possibly to an interruption of the charging process, possibly even to the melting of the charging adapter with the charging socket in the vehicle or the plug of the charging infrastructure if the charging adapters are overloaded and currents flow that are higher than the permissible capacity of the charging adapter.

Currently used charging adapters have a protective mechanism that reduces the charging current when the charging adapter heats up above a certain temperature threshold value. This so-called “derating” process results in a sudden reduction, usually halving, of the charging current. If the threshold value is exceeded, a resistor is switched on and detected by the charging controller, for example the battery management system, of the vehicle and/or the charging device, triggering the derating. If the temperature exceeds a further threshold value, a further resistor is switched on and detected by the vehicle or the charging device, which causes the charging process to be aborted.

Here, a charging adapter is only recognized by the charging device and/or the vehicle when it is already in derating mode and is only charged at a reduced current strength for the remainder of the charging process. This increases the charging time.

CN 1 13 858 986 A discloses a charging adapter, a vehicle, and a method for detecting a charging and discharging mode of a vehicle. The charging adapter comprises a DC-side connection port which is suitable for connection to a DC charging device, an AC-side connection port which suitable for connection to an AC charging socket on a vehicle, and a first resistance unit and a first switch.

CN 1 17 996 520 A discloses an adapter with a connection housing and a connection terminal set arranged therein.

CN 2 11 859 074 U discloses a charging switching device and an electric vehicle, the charging switching device comprises a charging switching input end, a normally closed temperature switch and a charging switching output end, which are arranged on a base body of the charging switching device.

US 2013/0300429 A1 discloses a method involving detecting, by a charging device for electric vehicles, whether a plug which is configured to supply power to an electric vehicle with a current is electrically connected to a socket of the charging device for electric vehicles; obtaining electrical measurement values by the charging device for electric vehicles at one end of one or more conductors which are accessible via the plug; determining a status of the one or more conductors based on the obtained electrical measurement values; and indicating whether the charging device for electric vehicles is ready for use.

Exemplary embodiments of the invention are directed to an improved method for charging an electrically operated vehicle on a charging device using a charging adaptor between a charging socket on the vehicle side and an external charging plug of the charging device, as well as to a system for carrying out such a method.

According to an aspect of the invention, a method for charging an electrically operated vehicle on a charging device using a charging adapter between a charging socket on the vehicle side and an external charging plug of the charging device is proposed, comprising establishing an electrical connection between vehicle-side connections of the charging adapter and the charging socket of the vehicle; establishing an electrical connection between the external charging plug of a charging cable of the charging device and plug-side connections of the charging adapter; checking, by means of control electronic system of the vehicle, whether the charging plug has a test resistance specific to the charging plug; setting a predeterminable temporal charging profile for a charging process by the control electronic system depending on the presence of the test resistance.

The proposed method makes it possible to detect a charging adapter when carrying out the charging process of an electrically operated vehicle. This particularly applies to the use of charging adapters for charging vehicles with NACS charging sockets on charging devices with CCS1 charging plugs, and for charging vehicles with CCS1 charging sockets on charging devices with NACS charging plugs. It is proposed to implement the detection of the charging adapter by means of a defined resistor, the presence of which is checked when the charging adapter is plugged into the charging socket of the vehicle.

CCS1 charging plugs have a test resistor. Thus, depending on the standard of the charging plug of the vehicle, it can be determined whether a charging adapter has to be used or not. The proposed method therefore proposes the control electronic system of the vehicle querying before or at the start of the charging process whether the test resistor is switched on or not, and in this way detecting the presence of the charging adapter.

This advantageously enables faster and safer charging of an electrically operated vehicle on a charging device. Temperature profiles in the charging plug on the side of the charging device and in the charging socket on the side of the vehicle can then be interpreted differently, and derating and thus a reduction in the charging current for the remainder of the charging process can be prevented.

If the absence of the test resistor is detected when the vehicle has a NACS charging socket or the presence of the test resistor is detected when the vehicle has a CCS1 charging socket, according to the invention, a charging current is maintained above a current limit for at least a period of time. When the vehicle has a NACS charging socket and no test resistor is detected, it can be assumed that a NACS charging plug is plugged in, since a CCS1 charging plug has a test resistor. Similarly, when the vehicle has a CCS1 charging socket and a test resistor is detected, it can be assumed that a CCS charging plug is plugged in. In both cases, no charging adapter is required, allowing charging with higher currents.

Alternatively, according to the invention, if the presence of the test resistor is detected when the vehicle has a NACS charging socket, or the absence of the test resistor is detected when the vehicle has a CCS1 charging socket, a charging current is kept below a current limit. When the vehicle has a NACS charging socket and a test resistor is detected, it can be assumed that a CCS1 charging plug is plugged in, since a CCS1 charging plug has a test resistor. Similarly, when the vehicle has a CCS1 charging socket and no test resistor is detected, it can be assumed that a NACS charging plug is plugged in. In both cases, a charging adapter is required, so charging should be carried out with a lower current below the critical current limit in order to prevent premature derating.

According to an advantageous design of the method, the test resistor can be switched on, in particular briefly, by actuating a switch of the charging plug when connecting the charging plug to the plug-side connections of the charging adapter. In this way, the test resistor does not have to be continuously switched on. However, by temporarily switching on the test resistor, its presence can be reliably detected by the control electronic system.

According to an advantageous design of the method, the charging process of the vehicle can be controlled by the control electronic system in such a way that the charging adapter is prevented from heating to a temperature that exceeds a threshold temperature. This advantageously prevents premature derating of the charging process.

According to a further aspect of the invention, a system comprising an electrically operated vehicle, a charging adapter, and a charging device for carrying out the method according to the invention is proposed, wherein the vehicle has a charging socket to which vehicle-side connections of the charging adapter can be connected. The charging device has a charging cable with a charging plug, which can be connected to plug-side connections of the charging adapter. The vehicle has a control electronic system which is formed to check, when the charging plug is connected to the charging adapter and the charging socket, whether the charging plug has a test resistance specific to the charging plug. Here, the control electronic system is formed to set a predeterminable temporal charging profile for a charging process depending on the presence of the test resistor.

The disclosed system makes it possible to detect a charging adapter when carrying out the charging process of an electrically powered vehicle. In particular, this applies to the use of charging adapters for charging vehicles with NACS charging sockets on charging devices with CCS1 charging plugs, and for vehicles with CCS1 charging sockets on charging devices with NACS charging plugs. It is proposed to implement the detection of the charging adapter using a defined resistor, the presence of which is checked when the charging adapter is plugged into the charging socket of the vehicle.

CCS1 charging plugs have a test resistor. Thus, depending on the standard of the charging socket of the vehicle, it can be determined whether or not a charging adapter has to be used. According to the method described above, the control electronic system of the vehicle can query whether or not the test resistor is switched on before or at the start of the charging process, thus detecting the presence of the charging adapter.

This advantageously enables faster and safer charging of an electrically operated vehicle at a charging device. Temperature profiles in the charging plug on the side of charging device and in the charging socket on the side of the vehicle can then be interpreted differently, and derating and thus a reduction in the charging current for the remainder of the charging process can be prevented.

According to an advantageous design of the system, the charging plug can have a switch by means of which the test resistor can be switched on, in particular briefly, when the charging plug is connected to the plug-side connections of the charging adapter. In this way, the test resistor does not have to be continuously switched on. However, by temporarily switching on the test resistor, its presence can be reliably detected by the control electronic system.

According to an advantageous design of the system, the control electronic system can be formed to control the charging process of the vehicle in such a way that heating the charging adapter to a temperature that exceeds a threshold temperature is prevented. This advantageously prevents premature derating of the charging process.

Further advantages emerge from the following description of the drawings. In the drawings, an exemplary embodiment of the invention is depicted. The drawings, the description and the claims include numerous features in combination. The person skilled in the art will expediently also consider the features individually and combine them to form further meaningful combinations.

### BRIEF DESCRIPTION OF THE DRAWING FIGURES

Here are shown in:

FIG. 1 an overview of a system according to an exemplary embodiment of the invention for carrying out a method according to the invention for charging an electrically operated vehicle on a charging device using a charging adapter between a vehicle-side charging socket and an external charging plug of the charging device;

FIG. 2 a system diagram of the system with the electrically operated vehicle, the charging adapter and the charging device according to the exemplary embodiment in FIG. 1;

FIG. 3 a system diagram of the charging adapter;

FIG. 4 an overview of a system with the electrically operated vehicle, the charging adapter and the charging device according to a further exemplary embodiment of the invention; and

FIG. 5 a system diagram of the system according to the exemplary embodiment in FIG. 4.

In the figures, the same or similar components are numbered with the same reference numbers. The Figures only show examples and are not to be understood to be limiting.

### DETAILED DESCRIPTION

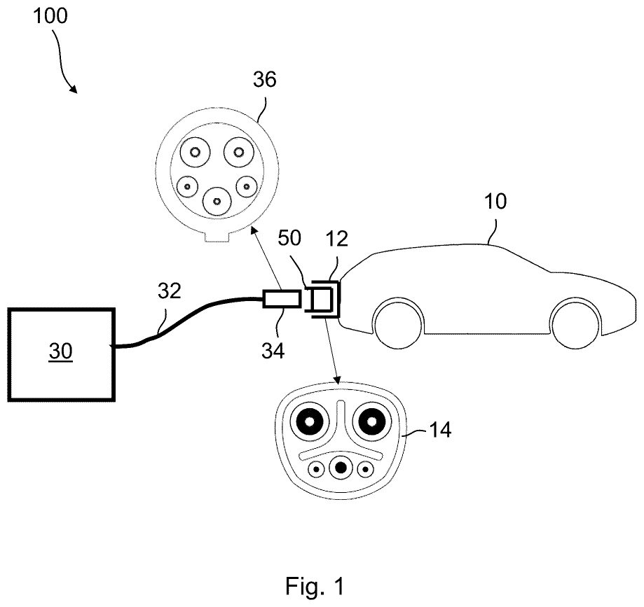

FIG. 1 shows an overview of a system 100 according to an exemplary embodiment of the invention for carrying out a method according to the invention for charging an electrically operable vehicle 10 on a charging device 30 using a charging adapter 50 between a vehicle-side charging socket 12 and an external charging plug 34 of the charging device 30.

The system 100 comprises the electrically operated vehicle 10, the charging adapter 50, and the charging device 30. According to a prescribed plug-in sequence, the charging adapter 50 is first plugged into the charging socket 12 of the vehicle and then the charging plug 34 of the charging cable 32 of the charging device 30 is connected to the other side of the charging adapter 50 already arranged on the vehicle 10.

The plug-in sequence can be predetermined and/or recommended via the mechanical design of the charging socket 12 and charging plug 34 and/or via an operating manual.

In the exemplary embodiment depicted in FIG. 1, the charging socket 12 is formed as an NACS charging socket 14, while the charging plug 34 is a CCS1 charging plug 36. Since the two plug standards are different, a charging adapter 50 with the appropriate thus corresponding connectors must be used.

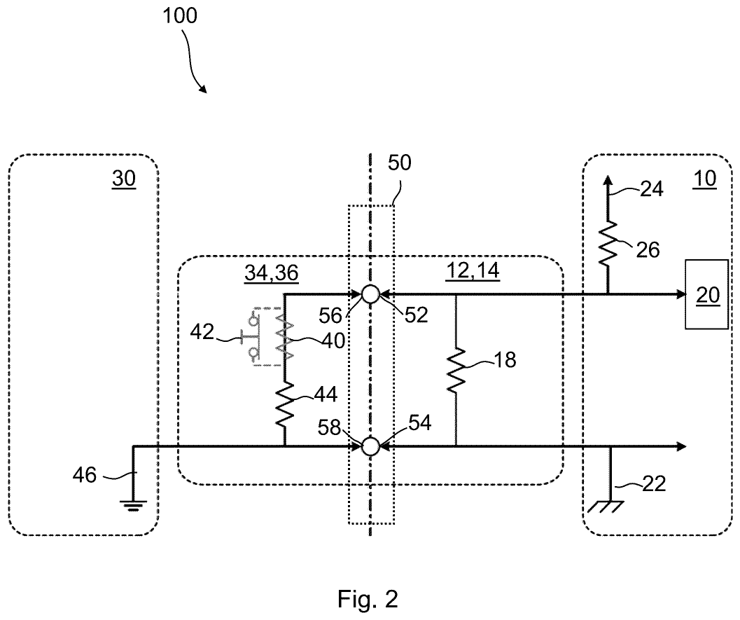

In FIG. 2, a system diagram of the system 100 with the electrically operated vehicle 10, the charging adapter 50, and the charging device 30 according to the exemplary embodiment in FIG. 1 is depicted.

The vehicle 10 has control electronic system 20 for detecting a charging plug 34 plugged into the charging socket 12 via two lines connected to the charging socket 12. This is achieved by a regulated supply voltage 24, for example +5V, which is coupled to the input of the control electronic system 20 via a resistor 26. Moreover, the vehicle 10 has a vehicle ground 22.

The charging adapter 50, which is depicted as a rectangle with a dotted line, is connected to the charging socket 12 with vehicle-side connectors 52, 54. A resistor 18 is switched between the two connecting lines of the charging socket 12.

The charging plug 34 of the charging device 30 is connected to the plug-side connections 56, 58 of the charging adapter 50. The ground 46 of the charging device 30 is here connected to the vehicle ground 22.

The CCS1 charging plug 36, which in this exemplary embodiment is present as the charging plug 34, has a test resistor 40, which is switched via a switch 42, for example via a rocker switch of the charging plug 36, in series with a further resistor 44 to the plug-side connection 56 of the charging adapter 50 and thus to the input of the control electronic system 20 of the vehicle 10.

The control electronic system 20 is formed to check, when the charging plug 34 is connected to the charging adapter 50 and the charging socket 12, whether the charging plug 34 has this test resistor 40 specific for the charging plug 34.

Depending on the presence of the test resistor 40, a predeterminable temporal charging profile for a charging process can then be set by the control electronic system 20.

In the case of the CCS1 to NACS charging adapter 50, for example, when plugging the CCS1 charging plug 36 of the charging device 30 into the charging adapter 50 on the vehicle 10, the test resistor 40 is switched on, in particular briefly, by actuating the switch 42, that is before the actual charging process begins. This can be done, for example, by inserting the CCS1 charging plug 36 into the plug-side connections 56, 58 of the charging adapter 50 via a rocker switch, whereby the test resistor 40 is incorporated.

This is detected by the control electronic system 20, which can be, for example, the charging controller and/or the battery management system, of the vehicle 10, which monitors the presence of this test resistor 40. The control electronic system 20 then optimizes the charging process for charging with the existing charging adapter 50. The charging power is chosen or reduced depending on the time in such a way that the charging adapter 50, if possible, does not heat up above the threshold value at which derating occurs. The onset of derating can thus be delayed or avoided and thus the charging speed increased.

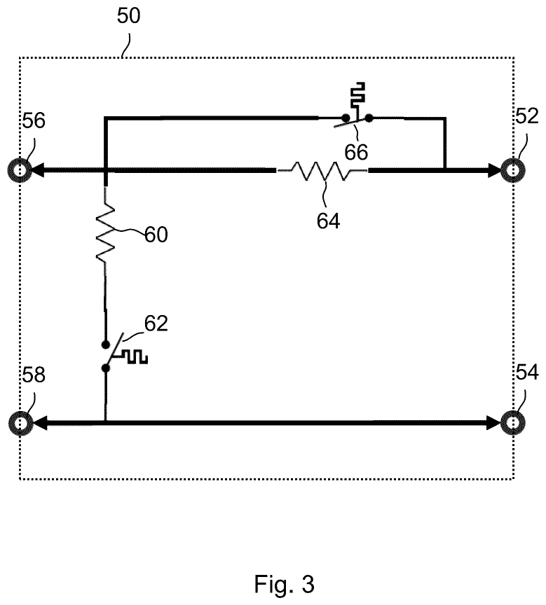

In FIG. 3, a system diagram of the charging adapter 50 with the vehicle-side connections 53, 54 and the plug-side connections 56, 58 is additionally depicted. The charging adapter 50 has a resistor 60 that can be switched in parallel to the plug-side connections 56, 58 using a temperature-dependent switch 62, and a resistor 64 in the connection of the plug-side connection 56 to the vehicle-side connection 52, which can be bridged with a further temperature-dependent switch 66. In the initial state in FIG. 3, this resistor 66 is depicted bridged, while the resistor 60 is not switched on.

If the temperature threshold is exceeded, the resistor 60 is switched on and detected by the control electronic system 20 of the vehicle 10 and/or the charging device 30, whereupon derating, for example halving the charging current, is triggered. If the temperature exceeds a further threshold value, the resistor 64 is switched on via the switch 66 and detected by the vehicle 10 or the charging device 30, which causes the charging process to be aborted.

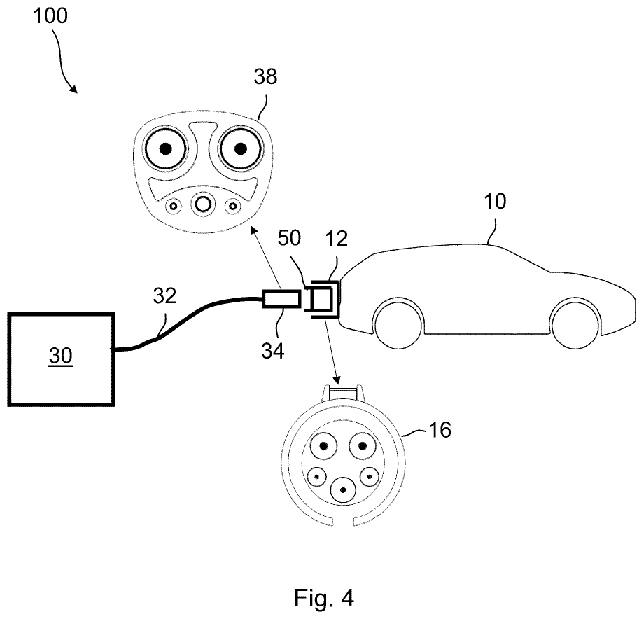

FIG. 4 shows an overview of a system 100 with the electrically operated vehicle 10, the charging adapter 50 and the charging device 30 according to a further exemplary embodiment of the invention.

In the exemplary embodiment depicted in FIG. 4, the charging socket 12 is formed as a CCS1 charging socket 16, while the charging plug 34 is an NACS charging plug 38. Since the two plug standards are different, a charging adapter 50 with the appropriate thus corresponding connections must also be used.

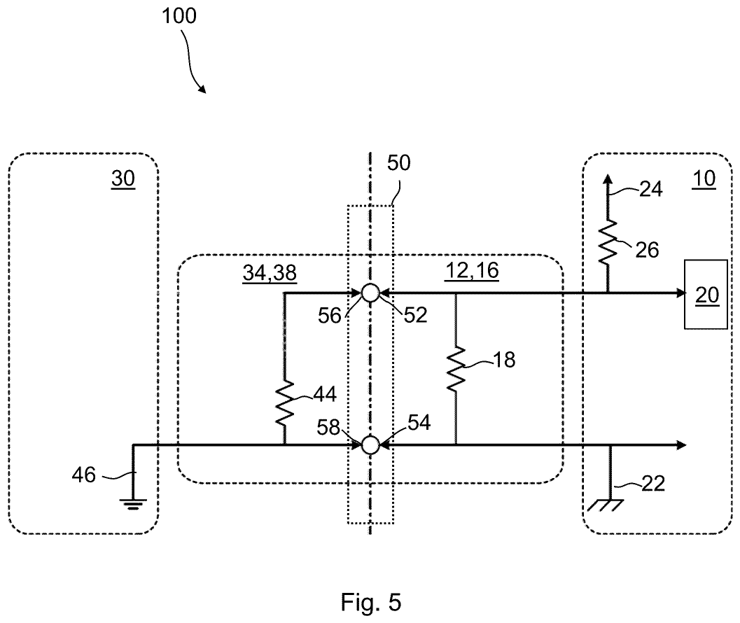

In FIG. 5, the system diagram of the system 100 according to FIG. 4 is additionally depicted.

The system diagram depicted in FIG. 5 substantially corresponds to the system diagram depicted in FIG. 2. In contrast to this, the NACS charging plug 38, however, does not have a test resistor 40.

In the case of the NACS on the CCS1 charging adapter 50, when the charging plug 34 or charging adapter is plugged back into the charging socket 12 of the vehicle, the control electronic system 20 performs a check as to whether or not the test resistor 40 is present. If the test resistor is not present, a charging adapter 50 must be present, since a CCS1 charging plug 36 has the test resistor as standard and the vehicle has a CCS1 charging socket 16.

If a CCS1 charging plug 36 is plugged into the vehicle 10 with CCS1 charging socket 16, the test resistor 40 is briefly detected. If this is not present and only the resistor 44 is detected instead, only one NACS charging plug 38 of an NACS charging device 30 can be plugged in.

Depending on the presence of the test resistor 40, a predeterminable temporal charging profile for a charging process can thus be set by the control electronic system 20. The charging process of the vehicle 10 can be controlled by the control electronic system 20 in such a way that heating of the charging adapter 50 to a temperature that exceeds a threshold temperature is prevented.

According to the proposed method, if the absence of the test resistor 40 is detected when a NACS charging socket 14 of the vehicle 10 is present, or the presence of the test resistor 40 is detected when a CCS1 charging socket 16 of the vehicle 10 is present, a charging current above a current limit value can be maintained for at least a period of time. However, if the presence of the test resistor 40 is detected when a NACS charging socket 14 of the vehicle 10 is present, or the absence of the test resistor 40 is detected when a CCS1 charging socket 16 of the vehicle 10 is present, a charging current can be maintained at a value below a current limit, thus avoiding premature derating of the charging process.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMBERS

10 Vehicle
12 Charging socket
14 NACS charging socket
16 CCS1 charging socket
18 Resistor
20 Control electronic system
22 Vehicle ground
24 Supply voltage
26 Resistor
30 Charging device
32 Charging cable
34 Charging plug
36 CCS1 charging plug
38 NACS charging plug
40 Test resistor
42 Switch
44 Resistor
46 Ground
50 Charging adaptor
52 Vehicle-side connection
54 Vehicle-side connection
56 Plug-side connection
58 Plug-side connection
60 Resistor
62 Switch
64 Resistor
66 Switch
100 System

What is claimed is:

1. A method for charging an electrically operated vehicle on a charging device using a charging adapter between a vehicle-side charging socket and an external charging plug of the charging device, the method comprising
establishing an electrical connection between vehicle-side connections of the charging adapter and the charging socket of the vehicle;
establishing an electrical connection between the external charging plug of a charging cable of the charging device and plug-side connections of the charging adapter;
checking, by a control electronic system of the vehicle, whether the external charging plug has a test resistor specific to the external charging plug; and
setting, by the control electronic system of the vehicle, a predetermined temporal charging profile to charge the electrically operated vehicle depending on whether the checking indicates the external charging plug has the test resistor specific to the external charging plug,
wherein
a charging current of the charge is maintained above a current limit value for at least a period of time when
the checking indicates the external charging plug does not have the test resistor specific to the external charging plug when a NACS charging socket of the vehicle is present, or
the checking indicates the external charging plug has the test resistor specific to the external charging plug when a CCS1 charging socket of the vehicle is present, or
the charging current of the charge is maintained below the current limit value when
the checking indicates the external charging plug has the test resistor specific to the external charging plug when the NACS charging socket of the vehicle is present, or
the checking indicates the external charging plug does not have the test resistor specific to the external charging plug and the CCS1 charging socket of the vehicle is present.

2. The method of claim 1, wherein the test resistor is switched on by actuating a switch of the external charging plug when connecting the external charging plug to the plug-side connections of the charging adaptor.

3. The method of claim 1, wherein the charging of the vehicle is controlled by the control electronic system of the vehicle in such a way to prevent the charging adaptor heating up to a temperature exceeding a threshold temperature.

4. A system comprising:
a charging adapter;
an electrically operated vehicle comprising a control electronic system and a vehicle-side charging socket configured to connect to vehicle-side connections of the charging adaptor; and
a charging device comprising a charging cable with a charging plug configured to be connected to plug-side connections of the charging adaptor,
wherein the control electronic system is configured to
check whether the charging plug has a test resistor specific to the charging plug; and
set a predetermined temporal charging profile to charge the electrically operated vehicle depending on whether the checking indicates the charging plug has the test resistor specific to the charging plug,
wherein
the control electronic system is configured to maintain a charging current of the charge is above a current limit value for at least a period of time when
the check indicates the charging plug does not have the test resistor specific to the charging plug when a NACS charging socket of the vehicle is present, or
the check indicates the charging plug has the test resistor specific to the charging plug when a CCS1 charging socket of the vehicle is present, or
the control electronic system is configured to maintain the charging current of the charge below the current limit value when
the checking indicates the charging plug has the test resistor specific to the charging plug when the NACS charging socket of the vehicle is present, or
the checking indicates the charging plug does not have the test resistor specific to the charging plug and the CCS1 charging socket of the vehicle is present.

5. The system of claim 4, wherein the charging plug has a switch configured to switch on the test resistor when the charging plug is connected to the plug-side connections of the charging adaptor.

6. The system of claim 4, wherein the control electronic system is configured to control the charging of the vehicle in such a way to prevent the charging adaptor heating up to a temperature exceeding a threshold temperature.
